(19) United States
(12) Patent Application Publication
(10) Pub. No.: US 2014/0136407 A1
(43) Pub. Date: May 15, 2014

(54) System and Method for Conducting Financial Transactions

(71) Applicants: Mitchell P. HAZAM, Gainesville, VA (US); Jean-Luc V. GIRARD, Warrenton, VA (US)

(72) Inventors: Mitchell P. HAZAM, Gainesville, VA (US); Jean-Luc V. GIRARD, Warrenton, VA (US)

(21) Appl. No.: 13/841,291

(22) Filed: Mar. 15, 2013

Related U.S. Application Data
(60) Provisional application No. 61/726,361, filed on Nov. 14, 2012.
(60) Provisional application No. 61/726,354, filed on Nov. 14, 2012.

(51) Int. Cl. G06Q 20/10

(52) U.S. Cl. CPC G06Q 20/108
USPC 705/42; 705/39

(57) ABSTRACT

A system and method for executing a financial transaction via an electronic device is provided. The methods comprises several steps. First, a request is received to designate a first account for use in a financial transaction is received, wherein the first account is associated with a first account icon located in a first location of an interface. Second, a request is received to move the first account icon to a second location on the interface, wherein the second location is associated with the financial transaction. Third, the financial transaction is initiated.

### RELATED APPLICATION INFORMATION

This application claims priority to and the benefit of: (1) provisional application Ser. No. 61/726,361, filed on Nov. 14, 2012, titled “Transaction Panel for Mobile Banking,” and (2) provisional application Ser. No. 61/726,354, titled “Inline Transfer Gesture for Mobile Banking.” This application is also related to the co-pending application filed on Mar. 15, 2013, titled “System and Method for Conducting Financial Account Transfers,” and assigned Ser. No. ______. The preceding applications, including all specifications and drawings, are incorporated by reference herein in their entirety.

### FIELD OF THE INVENTION

The invention relates generally to systems and methods for executing financial transactions via electronic devices and user interfaces.

### BACKGROUND OF THE INVENTION

The Internet and mobile communications have revolutionized the manner in which individuals conduct financial transactions. With increasing ease, customers of financial institutions are able to check account balances, pay bills, transfer funds, and conduct other types of financial transactions from virtually anywhere. The more recent proliferation of smartphones, tablets and other mobile electronic devices has made it even easier for customers to access financial information and conduct financial transactions.

Despite all the recent advances, however, conducting financial transactions online remains a fairly cumbersome process. For example, many online financial systems and applications require the user to maneuver through multiple screens, interfaces or web sites in order to initiate and conduct transactions. In addition, many require the user to engage with drop down boxes to designate accounts, while others require the manual input of necessary account details and information. As a result, the process is time-consuming and fails to fully leverage available technologies.

These and other deficiencies exist.

### SUMMARY OF THE INVENTION

An exemplary embodiment includes a method with the steps of: receiving, electronically, a request to designate a first account for use in a financial transaction, wherein the first account is associated with a first account icon located in a first location of an interface; receiving, electronically, a request to move the first account icon to a second location on the interface, wherein the second location is associated with the financial transaction; and initiating, electronically, the financial transaction.

Another exemplary embodiment includes a system, comprising: a processor; and a memory comprising computer-readable instructions which when executed by the processor cause the processor to perform the steps comprising: receiving, electronically, a request to designate a first account for use in a financial transaction, wherein the first account is associated with a first account icon located in a first location of an interface; receiving, electronically, a request to move the first account icon to a second location on the interface, wherein the second location is associated with the financial transaction; and initiating, electronically, the financial transaction. In other exemplary embodiments, a system, a comprising: a user I/O module receiving instructions from a user regarding a financial transaction using a first account, wherein the instructions are provided by the user by touching a screen associated with a device; an accounts module for processing data related to the first account and the financial transaction; and a back-end systems communication module for transmitting data relating to the financial transaction.

These and other embodiments and advantages of the invention will become apparent from the following detailed description, taken in conjunction with the accompanying drawings, illustrating by way of example the principles of the various exemplary embodiments.

### BRIEF DESCRIPTION OF THE DRAWINGS

FIG. 1 is a diagram of a system in accordance with an exemplary embodiment.

FIG. 2 is a diagram of a processing module in accordance with an exemplary embodiment.

FIG. 3 is a flow chart of a method for executing a financial transaction via an electronic device in accordance with an exemplary embodiment.

FIG. 4 is a diagram of an interface for executing a financial transaction via an electronic device in accordance with an exemplary embodiment.

FIGS. 5a and 5b are diagrams of interfaces for executing a financial transaction via an electronic device in accordance with an exemplary embodiment.

FIGS. 6a, 6b and 6c are diagrams of interfaces for executing a financial transaction via an electronic device in accordance with an exemplary embodiment.

FIG. 7 is a flow chart of a method for executing a financial transaction via an electronic device in accordance with an exemplary embodiment.

FIG. 8 is a diagram of an interface for executing a financial transaction via an electronic device in accordance with an exemplary embodiment.

FIGS. 9a and 9b are diagrams of interfaces for executing a financial transaction via an electronic device in accordance with an exemplary embodiment.

FIG. 10 is a diagram of an interface for executing a financial transaction via an electronic device in accordance with an exemplary embodiment.

FIG. 11 is a diagram of an interface for executing a financial transaction via an electronic device in accordance with an exemplary embodiment.

FIG. 12 is a diagram of an interface for executing a financial transaction via an electronic device in accordance with an exemplary embodiment.

FIG. 13 is a diagram of an interface for executing a financial transaction via an electronic device in accordance with an exemplary embodiment.

FIG. 14 is a diagram of an interface for executing a financial transaction via an electronic device in accordance with an exemplary embodiment.

FIG. 15 is a diagram of an interface for executing a financial transaction via an electronic device in accordance with an exemplary embodiment.

FIG. 16 is a diagram of an interface for executing a financial transaction via an electronic device in accordance with an exemplary embodiment.

### DETAILED DESCRIPTION OF THE PREFERRED EMBODIMENTS

It will be readily understood by those persons skilled in the art that the embodiments of the inventions described herein are capable of broad utility and application.

Accordingly, while the invention is described herein in detail in relation to the exemplary embodiments, it is to be understood that this disclosure is illustrative and exemplary of embodiments of the invention and is made to provide an enabling disclosure of the invention. Accordingly, the disclosure is not intended to be construed to limit the embodiments of the invention or otherwise to exclude any other such embodiments, adaptations, variations, modifications and equivalent arrangements. While the various embodiments of the present invention are described in the context of portable devices and the providing of financial services through such devices, the methods and systems described herein may be applied to other related services involving interaction with similar devices.

The following descriptions are provided of different configurations and features according to exemplary embodiments. These configurations and features may relate to providing financial services through different types of devices, such as, for example, computers, smartphones, tablets, and other electronics devices. While certain nomenclature and types of applications/hardware are described, other names and application/hardware usage is possible and the nomenclature provided is done so by way of non-limiting examples only. Further, while particular embodiments are described, it should be appreciated that the features and functions of each embodiment may be combined in any combination as is within the capability of one of ordinary skill in the art. The attached Figures provide additional details regarding the present invention. It should also be appreciated that these exemplary embodiments are provided as non-limiting examples only.

According to exemplary embodiments, a system and method may be provided to enable a user to conduct financial transactions in an efficient and simple manner using a single screen or interface. Traditionally, he common way of moving a user through a transaction process involves a series of screens where the user selects various options to create a transaction, such as “To” and “From” Account, Date, Amount, etc., making the process laborious and time-consuming. The systems and methods described herein overcome this by providing, for example, a single screen transaction panel or interface that allows a user to create, initiate, and/or conduct a financial transaction (e.g., a transfer, payment and deposit) from a single interface. Use of a single interface allows a user to see all the relevant options in the transaction process as well as the details of their accounts.

According to other exemplary embodiments, a system and method may be provided to enable a user to transfer of funds between accounts in an efficient and simple manner. The common way of transferring money between accounts in a financial application (e.g., online) requires a user to select a “From” and “To” account from a drop down list in a transfer specific feature. This process is usually carried out through a sequential form operation involving multiple screens, some of which require the user to specify account numbers or other account information.

In contrast, the systems and methods described herein may comprise an inline transfer feature that provides a quick, convenient and visual way to move money between accounts. In some embodiments, the systems and methods described herein may enable a user to quickly and conveniently move money between accounts using a visual graphical user interface (GUI) that permits the easy and convenient transfer of funds between accounts. For example, a user may interact with a touch screen associated with a smartphone, tablet or other electronic device (e.g., device 110) to designate accounts and other transaction details. Other user interaction include oral instructions or commands, and or use of a mouse, pointer or other selection or designation device or apparatus.

For example, in some embodiments, the systems and methods described herein enable a user to designate an account from which funds are to be transferred, and identify a transfer amount using a movable slider or other icon. After designating the transfer amount, a transfer amount container or other identifier may be available for the user to selectively drag and drop (or double-tap) into an account container or other identifier associated with an account to which the user wishes to transfer funds. Upon completing the transfer, (e.g., upon completing the drag and drop or double-tap step) the requisite data (e.g., the identity of the accounts and the transfer amount) may be organized, packaged and sent back to a back-end mainframe, such as through series of web-service calls, for example. The complexity of the transaction is hidden from the user by the drag and drop or double-tap that leverages the inherent usability of the tablet, mobile and/or other computing platforms.

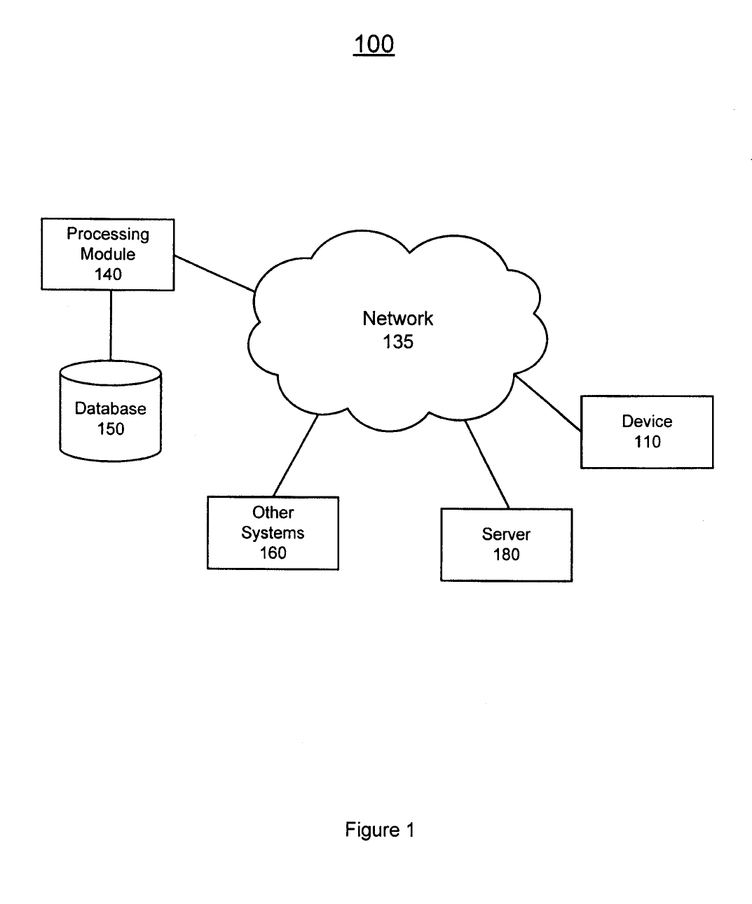

FIG. 1 is a system according to an exemplary embodiment of the invention. System 100 may provide various functionality and features associated with the performance of financial transactions, including, for example, the transferring of funds between accounts in the manner described herein. More specifically, system 100 may include a device 110, a network 135, a processing module 140, a database 150, and other systems 160. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized. It should be appreciated that system 100 may be integrated into and run on a computer, which may include a programmed processing machine which has one or more processors. Such a processing machine may execute instructions stored in a memory to process the data. System 100 may be integrated into and run on one or more computer networks which may each have one of more computers associated therewith.

As noted above, the processing machine executes the instructions that are stored in the memory or memories or persistent or non-transitory data storage devices to process data. This processing of data may be in response to commands by a user or users of the processing machine, in response to previous processing, in response to a request by another processing machine and/or any other input, for example. As described herein, a module performing functionality may have a processor.

According to exemplary embodiments, the system 100 may be configured to carry out the methods for performing financial transactions as described herein. The system 100 may have device 110 associated therewith. The primary function of device 110 may be to display information and receive user instructions or commands associated with or initiating financial transactions. A second device 110 (not shown) and an Nth device 110 (not shown) may be further associated with the system 100. The device 110 may be a processing machine. Device 110 may include software and/or modules to implement the methods described herein according to exemplary embodiments. Device 110 may provide processing, display, storage, communications, and execution of commands in response to inputs from a user thereof and respond to requests from the software and/or modules.

Device 110 may serve as a client side. Device 110 may be a “fat” client, such that the majority of the processing may be performed on the client. Alternatively, the device 110 may be a “thin” client, such that the majority of the processing may be performed in the other components of the system 100 as best shown in FIG. 1. Device 110 may be configured to perform other functions and processing beyond the methods described herein. Device 110 may be a part of a larger system associated with the financial institution. Devices 110 may be multi-functional in operation.

Device 110 may have a display and an input device associated therewith. The display may be monochrome or color. For example, the display may be a plasma, liquid crystal, or cathode ray tube type display. The displays may be touch screen type displays. The input device may be a single device or a combination of input devices. For example, the input devices may include a keyboard, both full-sized QWERTY and condensed, a numeric pad, an alpha-numeric pad, a track ball, a touch pad, a mouse, selection buttons, and/or a touch screen. As described above, the display may serve as an input device through using or incorporating a touch screen interface.

According to some embodiments, device 110 may be financial services devices. For example, a financial services devices, as used herein, may include machines, kiosks, and stations for performing financial services transactions. These devices include, but are not limited to, personal, desktop or laptop computers, automated teller machines (“ATMs”), personal teller machines (“PTMs”), financial self-service devices, financial services kiosks, financial transaction devices, portable electronic devices, or any other device or terminal through which financial transactions may be conducted. The financial services device may be a transaction device for conducting transactions with the financial institution.

Device 110 may provide various functionality and features for conducting transactions with a financial institution. For example, device 110 may be capable of transferring funds, accepting deposits, withdrawals, check cashing, statement printing, wires, bill pay and check printing. It should be appreciated that device 110 may be capable of other functions and features. Transactions may be supported relating to other financial institutions. For example, the device may be part of a network associated with more than one financial institution. The network may be managed by a third party.

Device 110 may be a portable or hand-held computing or electronic device, or other type of computing device, that has the described functionality. As a portable device, device 110 may have communication capabilities over both cellular and wireless type networks to transmit/receive data and/or voice communications. By way of non-limiting examples, device 110 may include such portable computing and communications devices as mobile phones (e.g., cell or cellular phones), smart phones (e.g., iPhones, Android based phones, or Blackberry devices), personal digital assistants (PDAs) (e.g., Palm devices), laptops, netbooks, tablets, or other portable computing devices. Device 110 may communicate and/or transmit/receive data over a wireless signal. Device 110 may include one or more computer processors and be capable of being programmed to execute certain tasks.

Device 110 may be communicatively coupled to a network 135. Network 135 may be a computer based network, with one or more servers and/or computer processors. For example, network 135 may be the Internet or a network connected to the Internet. The network 135 may be a satellite network, a cellular based network, or any other type of network through which data may be transmitted and received. Information and data may be exchanged through the network 135 between the various components of the system 100. In alternative embodiments, the network 135 may be a local area network within the financial institution that may be connected to or interface with the Internet. It should be appreciated that the network 135 may comprise or be a combination of local area networks, wide area networks, and external networks, which may be connected to the Internet. Network 135 may also be comprise any number of the above-referenced networks.

A processing module 140 may be communicatively coupled to the network 135 and accessible by device 110. The processing module 140 may perform operations associated with financial transactions as described herein. The processing module 140 may be hosted on or consist of one or more servers and/or general purpose computers, each having one or more computer processors associated therewith. Processing module 140 may, in some embodiments, be remotely accessed by device 110 in connection with the initiation and performance of financial transactions. Processing module 140 may also be stored, hosted or otherwise maintained within device 110. Processing module 140 may contain all or some of the necessary software and algorithms required to perform the various features described herein, such as, for example, selectively transferring funds between accounts in the manner described herein. In some embodiments, some modules of processing module 140 mare stored within device 110, while other modules are remotely stored or hosted, but otherwise accessible.

The processing module 140 may have a database 150 communicatively coupled thereto. For example, the database 150 may be accessible to processing module via Network 135, a local area network (LAN), wide area network (WAN), the Internet, or other communication network. The database 150 may contain data and information used by the system 100. For example, the database 150 may store account data for financial institution account holders. Additional information maybe contained therein related to the operation and administration of the system 100. The database 150 may include any suitable data structure to maintain the information and allow access and retrieval of the information. For example, the database may keep the data in an organized fashion. The database 150 may be a database, such as an Oracle database, a Microsoft SQL Server database, a DB2 database, a MySQL database, a Sybase database, an object oriented database, a hierarchical database, a flat database, and/or another type of database as may be known in the art that may be used to store and organize rule data as described herein.

The database 150 may be stored in any suitable storage device. The storage device may include multiple data storage devices. The multiple data storage devices may be operatively associated with the database 150. The storage may be local, remote, or a combination thereof with respect to the database. The database 150 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). The database may have back-up capability built-in. Communications with the database 150 may be over a network, such as the network 135, or communications may be over a direct connection between the database 150 and the processing module 140, as depicted in FIG. 1. Data may be transmitted and/or received from the database 150. Data transmission and receipt may utilize cabled network or telecom connections such as an Ethernet RJ 15/Category 5 Ethernet connection, a fiber connection, a traditional phone wireline connection, a cable connection or other wired network connection. A wireless network may be used for the transmission and receipt of data. In some embodiments, some or all of database 150 may be stored, hosted or otherwise maintained within device 110.

The system 100 may have other systems 160 associated therewith. These other systems 160 may include various data collection and support systems used by the financial institution to carry out a variety of functions. In some embodiments, other systems 160 may include or comprise the back-end mainframes that carry out the financial transactions based on data received from device 110 or processing module 140, for example, in connection with the financial transactions described herein. Similarly, other systems 160 may comprise a server or collection of servers from which applications can be downloaded onto smartphones or tablets (e.g., device 110), for example. Such application may, for example, correspond to processing module 140 and the features and functionalities for conducting financial transactions as described herein.

Device 110 may also establish communications with a server 180. Communications may be established over the network 135. Upon successful initiation of communications between the portable electronic device 170 and the server 180, data may be exchanged between the device 110 and the server 180. Data may be transmitted from device 110 to the server 180. Data may be transmitted from the server 180 to device 110, as needed.

It should be appreciated that the server may interact with other parts of the system 100, such as the processing module 140 and the other systems 160. The server 180 may be a single server or it may be multiple servers. The server 180 may server a variety of roles in the system 100, such as, for example, hosting modules (e.g., software and algorithms) required to perform the various financial transactions described herein, including, for example, the transferring funds between accounts.

The server 180 may have one or more storage devices associated therewith. The storage may be local, remote, or a combination thereof with respect to the server 180. The storage may utilize a redundant array of disks (RAID), striped disks, hot spare disks, tape, disk, or other computer accessible storage. In one or more embodiments, the storage may be a storage area network (SAN), an Internet small computer systems interface (iSCSI) SAN, a Fiber Channel SAN, a common Internet File System (CIFS), network attached storage (NAS), or a network file system (NFS). The storage may have back-up capability built-in. The back-up capability of the storage may be used to archive image data for later use. The back-up capability may be used for recovery of data in the event of a failure of the storage.

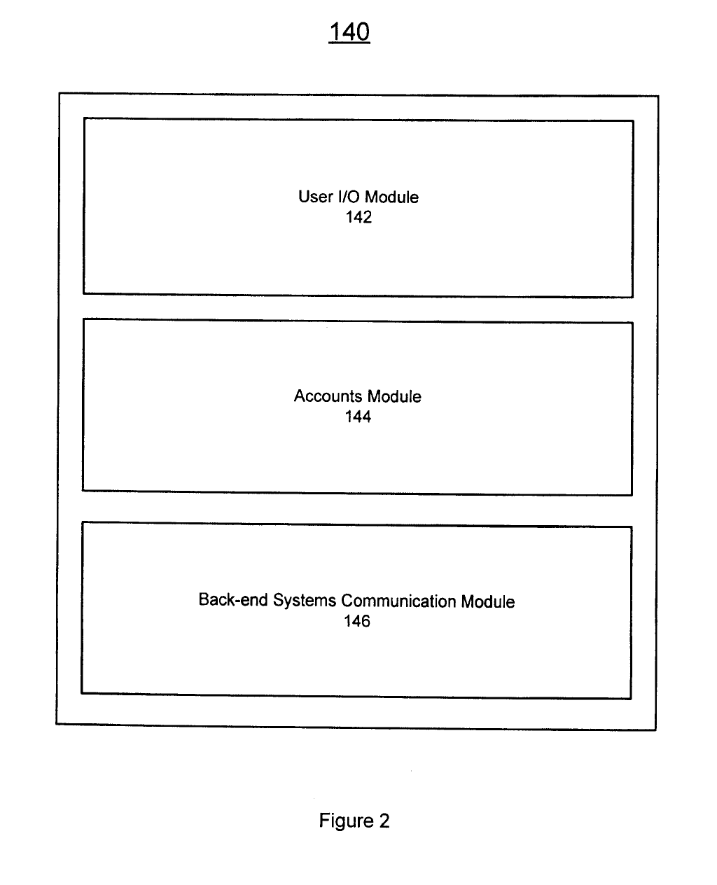

FIG. 2 depicts a an overview of processing module 140. In some embodiments, processing module 140 may include or comprise various modules (e.g., software and algorithms) that may be used to perform financial transactions as described herein. As shown, processing module 140 may include a user input/out (I/O) module 142, an accounts module 144 and a back-end systems communication module 146.

User I/O module may, for example, display graphical information to the user regarding financial services and transactions, including account details and information, such as account name or type, available balances, and other like information. Such graphical information may be displayed to the user via a touch screen display associated with a device (e.g., device 110), and may comprise graphical icons or elements that the user can selectively move to initiate and accomplish desired financial transactions. User I/O module may also receive instructions from a user regarding a particular financial transaction, such as, for example, the designation or selection of accounts, the deposit of funds, the transfer of funds from a first account to a second account, and other similar steps performed in conducting the various financial transactions described herein.

Accounts module 144 may, for example, process data related to the financial transactions described herein. For example, in connection with a financial transaction, such as the transfer of funds from a first account to a second account, for example, accounts module 144 may use data associated with those accounts to determine any appropriate parameters to the transfer request. For example, accounts module 144 may determined the available balance within an account, any limits on amounts that can be transferred, the types of accounts to which funds can be deposited, and any other limit or requirement that relates to a particular financial transaction. As used herein, the term account generally refers to any type of financial account, such as, for example, savings, checking, credit, or any other account known to a person of skill in the art. Accounts module 144 may obtain data associated with a user's accounts from any database, such as database 150 or any database associated with other systems 160 or back-end module 146 (described below), for example, or from any other system, external or otherwise, where account information is stored, maintained or otherwise made available.

Back-end systems communication module 146 may, for example, prepare data gathered by user I/O module 142 and accounts module 144—e.g., the identity of first and second accounts from and to which funds will be transferred, and the amount to be transferred—and send it to back-end mainframe systems (e.g., Other Systems 160 of FIG. 1). For example, back-end systems communication module 146 may organize the data in a way required by the back-end mainframe systems and transmit it thereto for processing and fulfillment. In some embodiments, such organized data may be transmitted as a series of web service calls. Other ways of transmitting data known to persons of skill in the art may be used. Back-end systems communication module 146 may also receive or obtain data from external systems that is required by processing module 140 to perform or carry out financial transactions requested by a user. Such data may include, for example, account identifiers and other information, transaction details (e.g., amount deposited or transfer), account holder identity(ies), and any other data or information needed to perform the transaction. In some embodiments, the data may be formatted in a manner corresponding or required by the back-end systems. For example, in some embodiments, the data may be formatted in an IFX web service format or other file format.

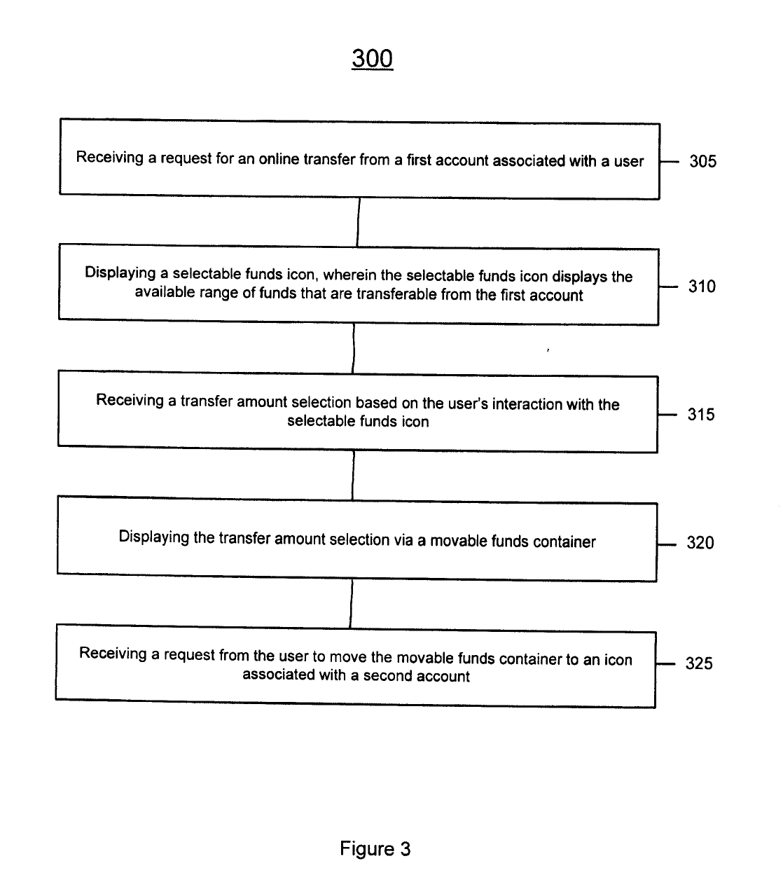

FIG. 3 depicts a flow chart of a method for conducting a financial transaction according to exemplary embodiments of the invention. Exemplary method 300 is provided by way of example, as there are a variety of ways to carry out the methods disclosed herein. The method 300 as shown in FIG. 3 may be executed or otherwise performed by one or a combination of various systems, such as device 110, processing module 140, or any other computer implemented system. Each block shown in FIG. 3 represents one or more processes, methods, and/or subroutines carried out in the exemplary method 300. Each block may have an associated processing machine or the blocks depicted may be carried out through one processor machine.

In describing method 300, a user of a smartphone or other portable device (e.g., device 110) with a touch screen is assumed to initiate a financial transaction. In particular, the user wishes to transfer funds from a first account to a second account by providing instructions via the touch screen of the smartphone or other portable device. In this example, we also assume that the various functions and processing required in method 300 are performed by processing module 140, which is either part of or accessible to the smartphone or other portable device.

Referring to FIG. 3, a customer interacting with a device may initiate the function of transferring funds from a first account to a second account in an inline manner. At step 305, a request is received for an online transfer from a first account associated with a user. The request may be received from a user interacting with the touch screen of the smartphone or other portable device, such as by designating (e.g., touching) a particular account icon and specifying a desire to transfer funds. For example, the particular smartphone or other portable device may host or have access to an application providing the user with various financial information and/or the ability to conduct financial transactions. Such an application may comprise, in whole or in part, processing module 140. In some embodiments, the display of information to the user, and the receiving of user instructions or commands, may be processed by user I/O module 142, as described in FIG. 2.

At step 310, once the user designates an account, the smartphone or other portable device may display a selectable funds icon displaying an available range of funds that are transferable from the associated account. For example, the selectable funds icon may comprise a slideable bar that is slideable between a first position corresponding to a minimum transfer amount and a second position corresponding to a maximum transfer amount. In determining the range of available funds, processing module 140 may determine the funds available in the account, a minimum transfer amount, or any limitation or requirement associated with the requested account or transfer. The position of the slideable bar between the minimum and maximum amounts corresponds to a transfer amount.

At step 315, the user may interact with the slideable bar to designate a specific transfer amount selection based on the user's interaction with the selectable funds icon. For example, the user may provide the specified amount by positioning the sliding element by interacting with the touch screen. In some embodiments, accounts module 144 may also determine any minimum or maximum transfer amounts based on the identity of the user, account, financial institution, or any other data or information. For example, a credit card account may require minimum transfer amount of $50 or a maximum daily transfer of $350. Likewise, a checking account may have a maximum transfer amount equal to the available balance, for example. Any such minimum and maximum transfer amounts may be presented via the slideable bar endpoints, for example.

At step 320, during the time the user is selectively positioning the slideable bar, a movable funds container may display a transfer amount corresponding to the position of the slideable bar. For example, if a slideable indicates a minimum transfer of $50 and a maximum transfer of $100, a position in the middle of the two ends would correspond to a transfer amount of $75. If the slideable bar is moved to the left, the transfer decreases to a minimum of $50, where if it is moved to the right the maximum amount would be $100. Once the user designates the desired transfer amount, the movable funds container may be ready to be associated with the appropriate target account.

At step 325, the user may initiate (e.g., touch on the screen) the movable funds container and drag it (or double tapped) to an icon or other designation of the account to which the funds are to be transferred. For example, the movable container may be moved from a location associated with the original account from which the funds are to be transferred to a second location associated with the account to which the funds are to be transferred. In some embodiments, accounts module 144 may determine whether an account to which funds are to be transferred is in fact able to receive such funds. For example, the account is not eligible to receive deposits or transfers, or is otherwise prevented by a rule or other parameter.

At step 330, a user may drop or otherwise associate the movable container with an icon or area corresponding to the second account. Upon doing so, the user may be asked to confirm the transfer, thereby initiating the transfer of the transfer amount from the first account to the second account. In some embodiments, back-end systems communication module 146 may, for example, prepare data gathered by user I/O module 142 and accounts module 144—e.g., the identity of first and second accounts from and to which funds will be transferred, the transaction type, and the amount to be transferred—and send it to back-end mainframe systems (e.g., Other Systems 160 of FIG. 1). Such organized data may be transmitted to the mainframe systems as a series of web service calls, for example.

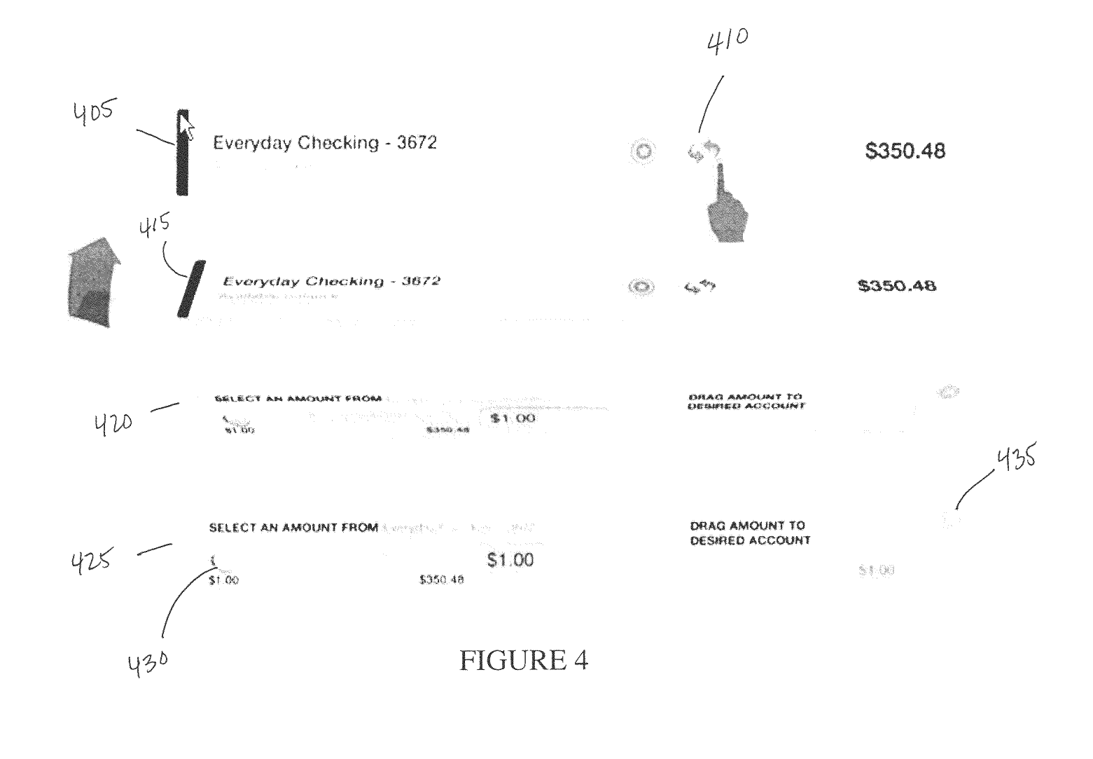

FIGS. 4-6 describe the transfer function as seen through some exemplary user interfaces and graphical icons that may be displayed via a touch screen. It should be appreciated that the specific graphical icons and features shown are examples and in no way limit the scope of the systems and methods described and claimed herein. One of ordinary skill in the art would appreciate that there are numerous ways to graphically carry out the various features and functions described and claimed herein.

FIG. 4, for example, shows the initiation of the account transfer transaction as performed via an account summary screen. The account summary screen may show an icon or container 405 associated with the user's everyday checking account, No. 3672 containing a balance of $350.48. When the user taps the transfer button 410, represented by the swirling arrows icon, the account container flips (as shown in 415 and 420), revealing the inline transfer feature on the backside of the panel, as shown in 425. As shown in the bottom of FIG. 4, the icon or container includes a slideable element 430 that is movable between a first position corresponding to $1.00 and a second position corresponding to $350.48, the available balance in the account.

Depending on the account type, the amount slider may automatically give the thresholds to the member to eliminate any errors that could be caused from over drafting or failing to meet minimum requirements. For example, in the case of a cash advance transfer from a credit card, the minimum will default to $50 and the maximum will be the cash advances limit the member can withdrawal. In the event the member has outstanding cash advances, this amount will be minus those outstanding items. In the example shown, the user has the option to cancel the transfer function at any time by tapping the “X,” as shown by 435 on the top right hand corner of the inline transfer panel.

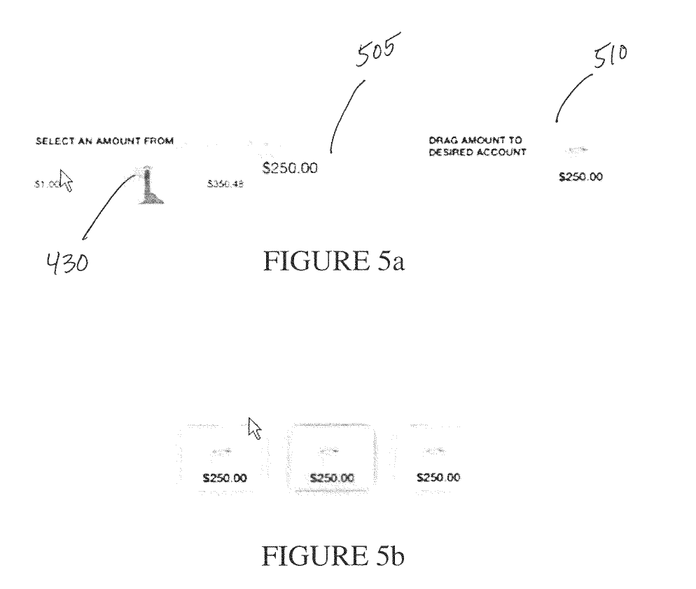

As shown in FIG. 5a, the user may adjust the transfer amount by either manually entering a value into the input field 505 or by sliding the amount slider 430, which dynamically changes the manual input value in 505. In some embodiments, if the user manually enters an amount greater than the threshold shown, the input filed may automatically revert to the maximum amount. After releasing the slider or entering an amount in the input field, the dollar display in the transfer amount container 510 may scale to representationally reflect the amount of the transfer related to the percentage of the amount in the “From” account. The amount container may start to glow (as reflected in the serial snapshots shown in FIG. 5b, for example), fading in and out until the user either starts changing the amount (causing the glow to cease), or touches the dollar value container at which point the glow will remain on and the transfer amount container will become active to the users touch. The system may also automatically enforce electronic transfer rules, and other restrictions to aid members and eliminate errors.

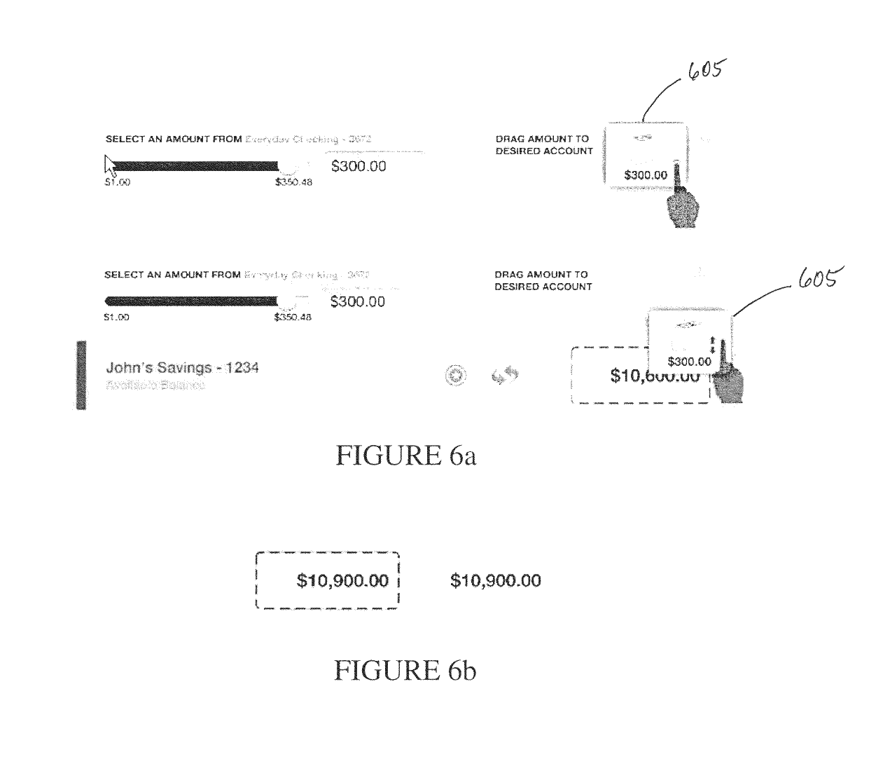

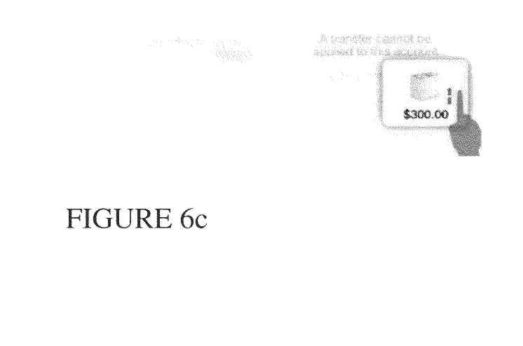

FIG. 6a depicts a user interface showing the user initiating transfer of $300 from the Everyday Checking Account No. 3672 to John's Savings Account No. 1234. As shown, a user may drag and drop the transfer amount icon 605 depicting the $300 from the checking account 3672 to the savings account 1234. In some embodiments, the user may only transfer money to an eligible “To” account based on which “From” account has been selected, as determined by accounts module 144, for example. The system may automatically disable ineligible accounts based on the “From” account. For example, on the user interface accounts that are not eligible to receive funds may be faded (e.g., to 30% opacity) or otherwise presented in a form to convey ineligibility. In some embodiments, as the user drags the transfer amount, the dollar value container may have 90-95% opacity. When the user hovers over an applicable account, blue dashed lines will appear giving the user a general target area and the account balance will update to reflect the change upon applying the transfer.

Upon dropping the container, the target area may glow (as indicated by the serial snapshots of FIG. 6b, for example) to indicate the amount has been applied and then it fades out, at which point a dialogue box may appear to either confirm or cancel the transfer. If the user attempts to drag and drop the container to an ineligible account, a message may appear in the box, such as, for example, “A transfer cannot be applied to this account,” as shown in FIG. 6c. If the user drops the transfer on this account, it may float back to it's original position and remain glowing to indicate the transfer that has been setup can still be made to another account.

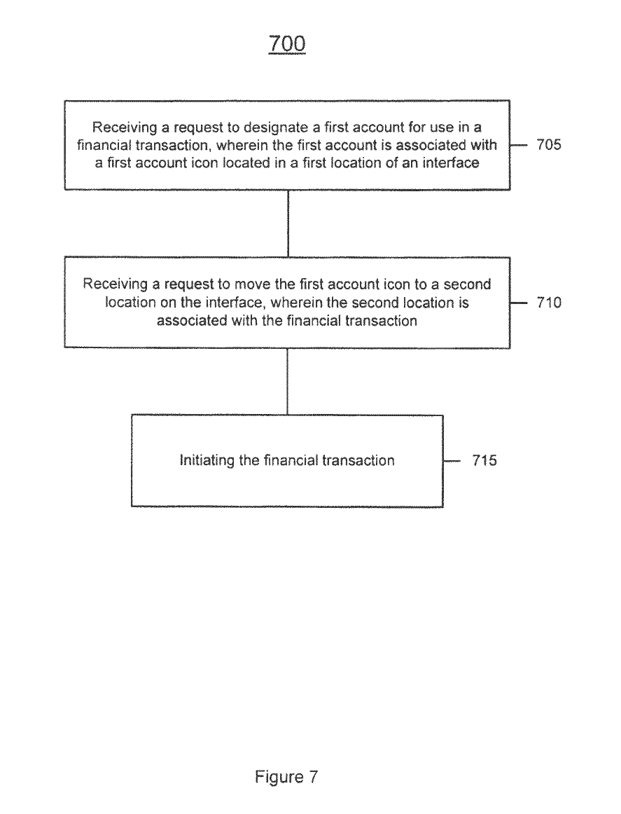

FIG. 7 depicts a flow chart of a method for conducting a financial transaction according to exemplary embodiments of the invention. Exemplary method 700 is provided by way of example, as there are a variety of ways to carry out the methods disclosed herein. The method 700 as shown in FIG. 7 may be executed or otherwise performed by one or a combination of various systems, such as a computer implemented system. Each block shown in FIG. 7 represents one or more processes, methods, and/or subroutines carried out in the exemplary method 300. Each block may have an associated processing machine or the blocks depicted may be carried out through one processor machine.

In describing method 700, a user of a smartphone or other portable device (e.g., device 110) with a touch screen is assumed to initiate a financial transaction. For example, the user wishes to designate an account for use in a financial transaction by providing instructions via the touch screen of the smartphone or other portable device. In this example, we also assume that the various functions and processing required in method 700 are performed by processing module 140, which is either part of or accessible to the smartphone or other portable device.

At step 705, a request is received for conducting a financial transaction using first account associated with a user. In some embodiments, the particular smartphone or other portable device may host or have access to an application providing the user with various financial information and/or the ability to conduct financial transactions as described herein. Such an application may comprise, in whole or in part, processing module 140. In some embodiments, the display of information to the user, and the receiving of user instructions or commands, may be processed by user I/O module 142, as described in FIG. 2. In some embodiments, the request may be received from a user interacting with the touch screen of the smartphone or other portable device, such as by designating (e.g., touching, clicking or otherwise initiating or selecting) a particular account icon associated with an account the user would like to use in connection with the financial transaction. For example, the financial transaction may comprise a deposit, a transfer, a bill or invoice payment, withdrawal, or any other type of financial transaction.

At step 710, the user may initiate (e.g., touch on the screen) the account icon and double tap it or drag it to an area or location on the interface associated with the financial transaction. For example, a left portion of the display, screen or interface may contain any number of account icons associated with the user's various accounts. The right side of the display, screen or interface may include a drop box, for example, wherein an account to be used in the financial transaction may be dropped or otherwise placed. In some embodiments, accounts module 144 may determine whether a selected or designated account is eligible to be to used in the financial transaction. For example, the account is not eligible to receive deposits or transfers, or is otherwise prevented by a rule or other parameter.

At step 715, a user may initiate the financial transaction by, for example, dropping or otherwise associating the account icon with an area corresponding to the financial transaction. For example, a section of the interface may have a dedicated space for position an account icon associated with the account that is to receive a deposit, or from which a bill or invoice is to be paid, or from which an amount is to be withdrawn or transferred. Other financial transactions are of course possible. Upon associating the account icon in the designated area, the user may be asked to confirm the transaction. In some embodiments, back-end systems communication module 146 may, for example, prepare data gathered by user I/O module 142 and accounts module 144—e.g., the identity of the selected account and relevant details of the financial transaction, e.g.,—and send it to back-end mainframe systems (e.g., Other Systems 160 of FIG. 1). Such organized data may be transmitted to the mainframe systems as a series of web service calls, for example, or other transmission protocols, such as, for example, blasts, API calls, or batches (e.g., text files).

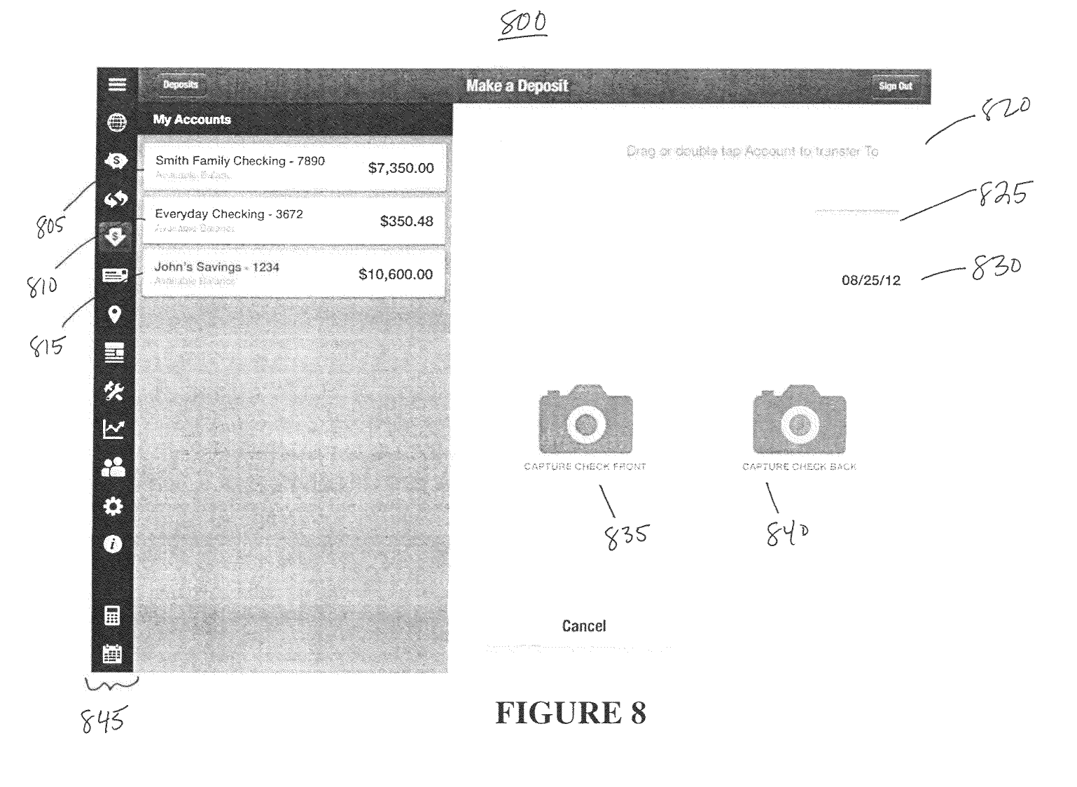

FIGS. 8-10 depict transaction panels or interfaces and graphical icons that may be displayed via a touch screen or other type of display. It should be appreciated that the specific panels, interfaces, graphical icons and features shown are examples and in no way limit the scope of the systems and methods described and claimed herein. One of ordinary skill in the art would appreciate that there are numerous ways to graphically carry out the various features and functions described and claimed herein.

FIG. 8, for example, shows, an example of a transaction panel or interface 800 for conducting a financial transaction. As shown in FIG. 8, the financial transaction is a deposit, but any other type of financial transaction may be performed, such as, for example, bill pay, transfer, and withdrawals. As shown, there are three account icons displayed on the left hand side of the interface 805, 810 and 815, corresponding to Smith Family Checking, Everyday Checking and John's Savings, respectively. To the right side of the interface is an area corresponding to the financial transaction, in this case a deposit based on a captured check. The area includes a “To” box 820 providing an area or box where the user can drag or double-tap the account to which the check is to be deposited. Also shown are boxes reflecting an amount of the deposit (825), the date of the deposit (830), and the image of the front and back of the captured check (835 and 840). Along the left hand side of the interface, are shown several icons 845, some of which may correspond to particular financial transactions. In this way, a user of interface 800 may easily create, initiate and/or conduct a transaction (e.g. transfer, make payment and deposit) from a single interface. This interface also allows a user to see all the relevant options in the transaction process as well as the details of their accounts.

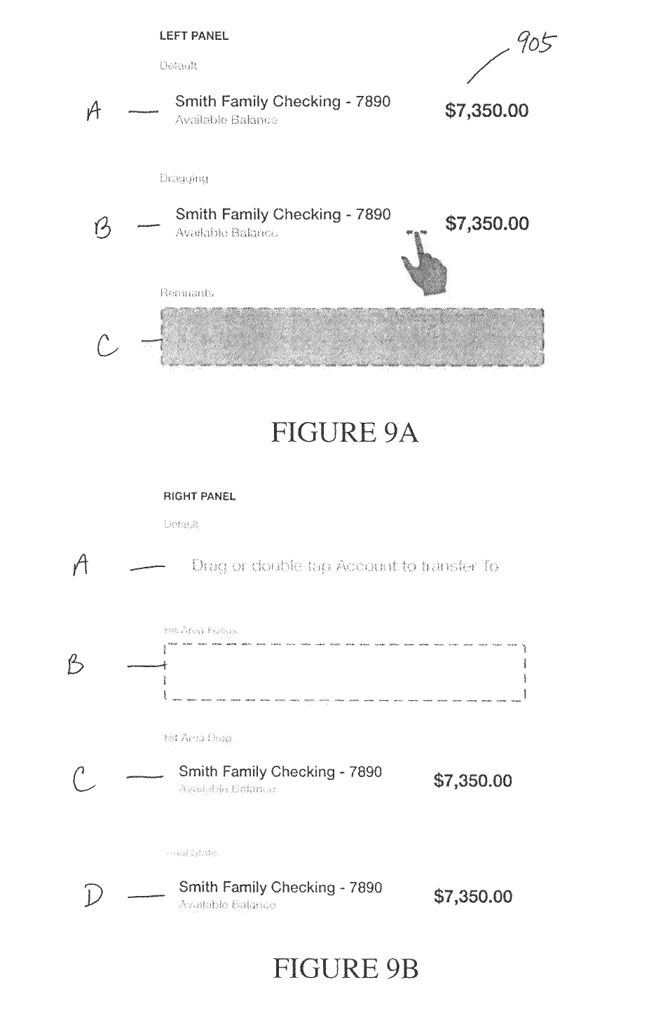

FIG. 9a depicts activity from the left hand side of the panel 800 in FIG. 8. Specifically, the Smith Family Checking account 905 is shown in its default (A), dragging (B), and post-default (C) forms. For example, as shown in FIG. 8, the default form is for the account icons to appear in the left hand side of the interface or panel. Once selected by the user, the user can drag and drop, or double tap, an account(s) from the left panel to the “To” and “From” (in the case of a transfer, for example) areas in the right panel of the transaction. Upon double tapping or dragging of an account, the right side panel may respond (e.g., indicate a readiness to receive an account icon or designation for use in the transaction). As the user drags the account, the account container may have 90-95% opacity. When the user hovers over an applicable “To” or “From” container, blue dashed lines may appear giving the user a general target. Upon dropping or otherwise designating the container, the target area may display the account and balance.

FIG. 9b depicts activity from the right hand side of the panel 800 in FIG. 8. Specifically, the “To” box is shown in its default (A), hit area focus (B), hit area drop (C) and final state (D) forms. Upon double tapping or dragging of an account, the right side panel may respond (e.g., indicate a readiness to receive an account icon or designation for use in the transaction). As the user drags the account, the account container may have 90-95% opacity. When the user hovers over an applicable “To” or “From” container (in the case of a transfer, for example), blue dashed lines may appear giving the user a general target. Upon dropping the container, the target area may display the account and balance.

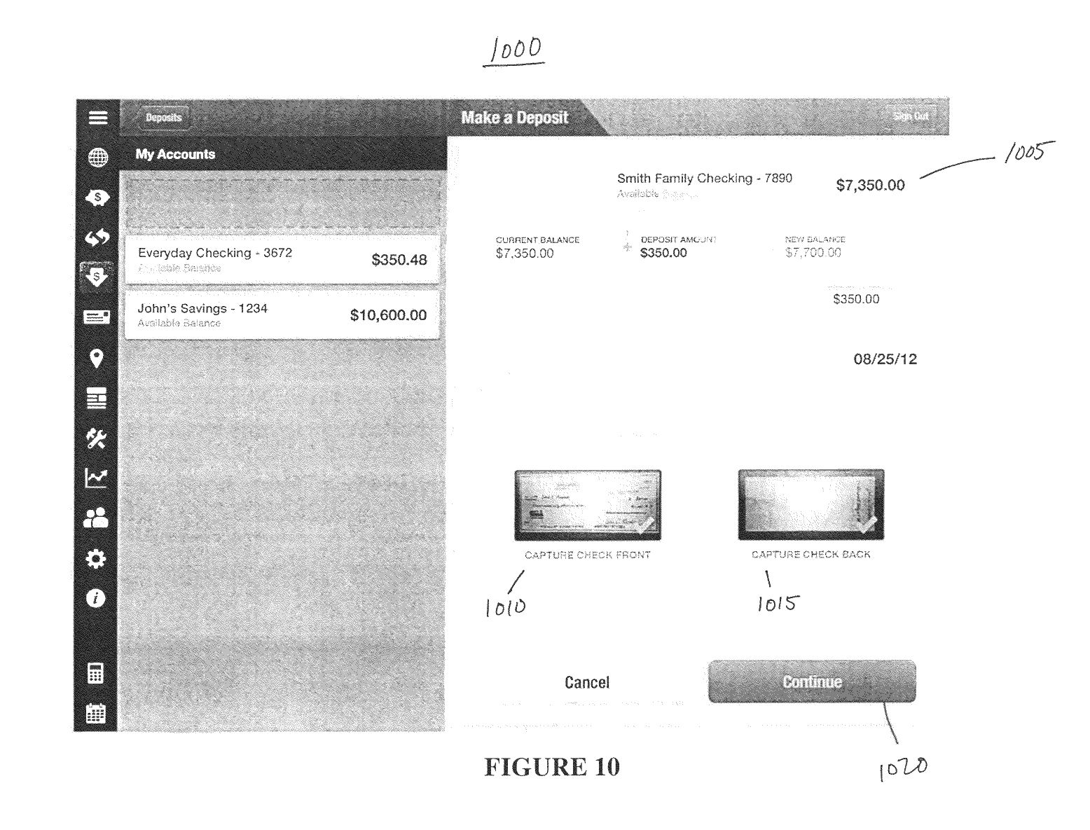

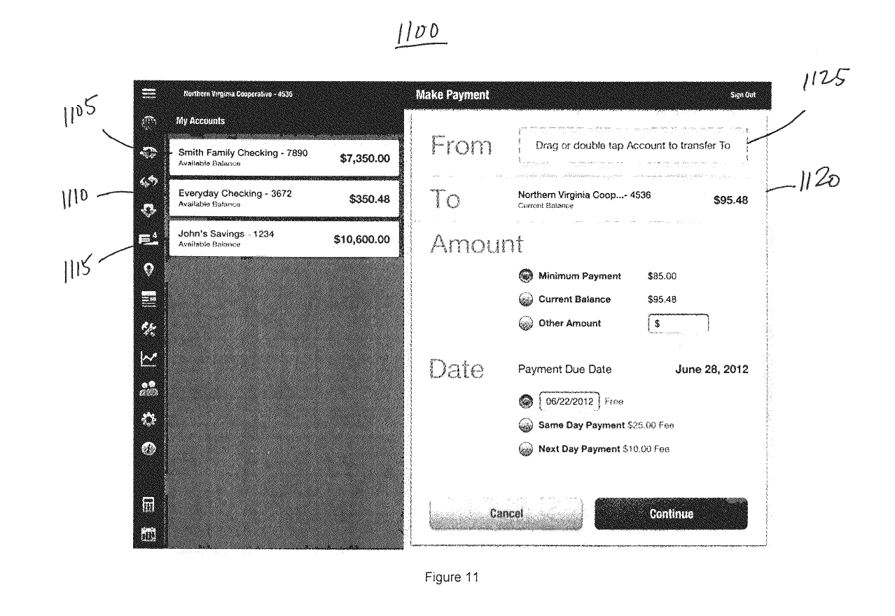

FIG. 10 shows a transaction panel or interface 1000 for conducting a financial transaction consisting of a deposit. As shown, the user has moved the Smith Family Checking Account 1005 to the right side of the interface and designated that account as the recipient of the $350.00 deposit from the capture check shown in 1010 and 1015. The deposit may then be initiated either upon the user dropping or otherwise associating the icon with the “TO” box, or upon the user initiating “continue” 1020 or other confirmation. As shown in FIG. 10, the financial transaction is a deposit, but any other type of financial transaction may be performed, such as, for example, bill pay, transfer, and withdrawals.

FIGS. 11-16 depict before and after transaction panels or interfaces and graphical icons associated with particular financial transactions. It should be appreciated that the specific panels, interfaces, graphical icons and features shown are examples and in no way limit the scope of the systems and methods described and claimed herein. One of ordinary skill in the art would appreciate that there are numerous ways to graphically carry out the various features and functions described and claimed herein.

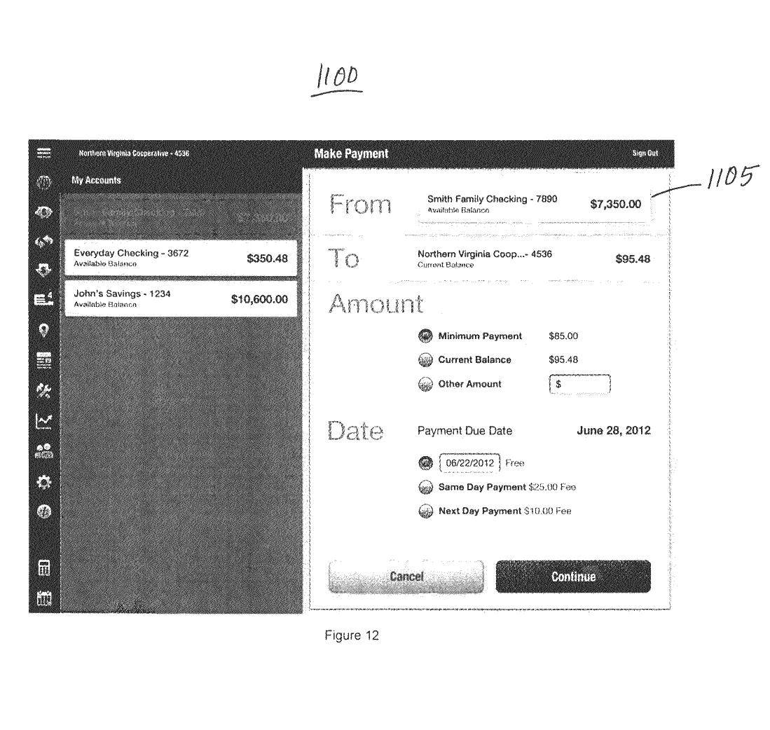

FIGS. 11 and 12, for example, show an interface or panel 1100 for conducting a payment transaction. As shown, a user may designate any of the accounts 1105, 1110, or 1115 to make a payment of $95.48 to Northern Virginia Coop 1120. In some embodiments, the user may have previously dragged 1120 onto the “To” box to initiate the payment. As shown in the right hand side of 1100, there is a designated area or box 1125 for the user to fill-in with the desired account 1105, 1110 or 1115. As described herein, the user may designate the desired account by dragging and dropping the account into 1125, double-tapping the desired account, or otherwise designating the desired account to be associated with 1125 and the payment transaction. FIG. 12 shows the user having selected account 1105, the Smith Family Checking Account, as the account from which the $95.48 payment to Northern Virginia Coop will be made. As shown, the user also has the ability to designate a different payment amount and the date upon which payment will be made.

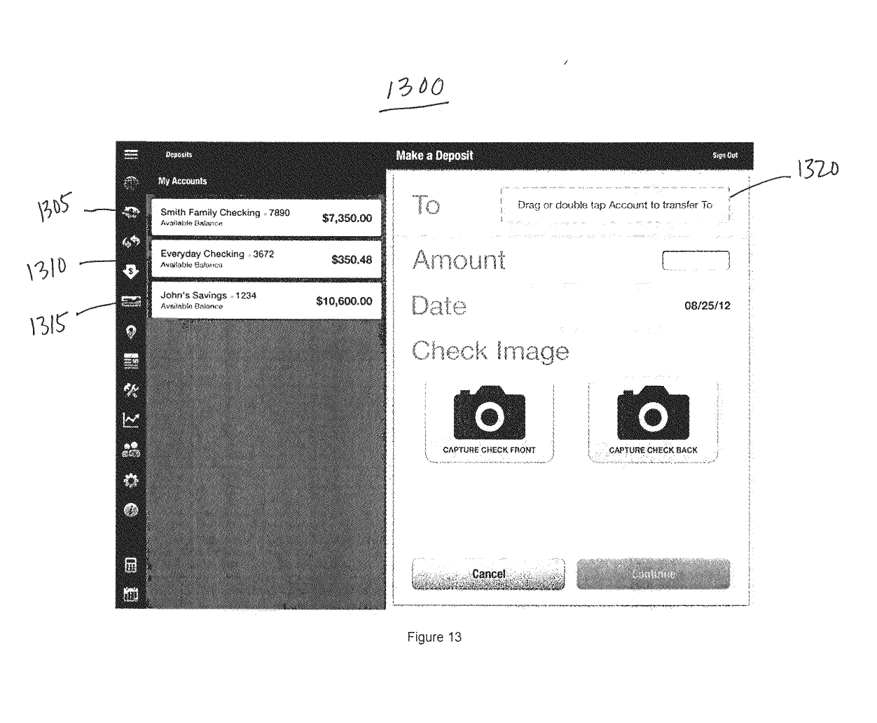

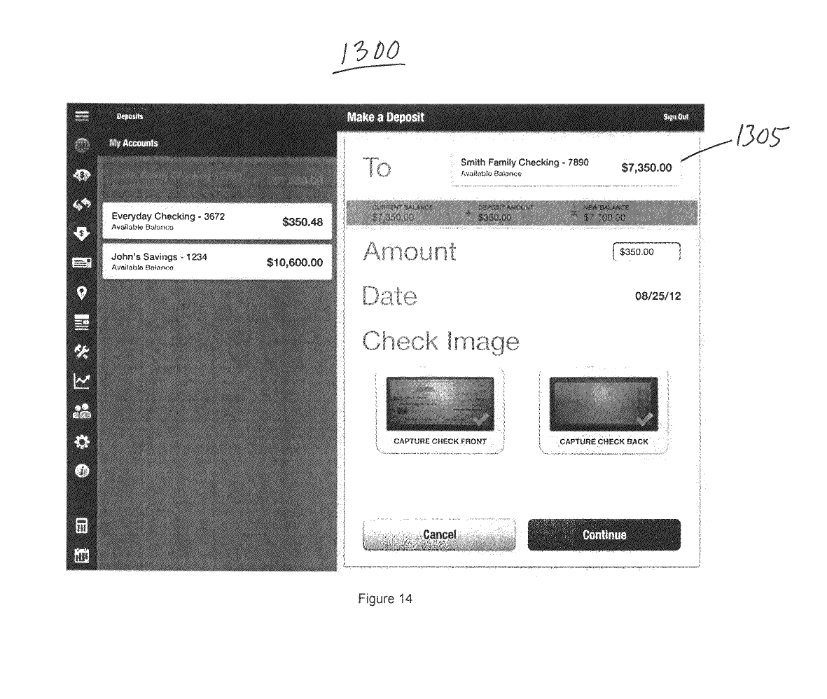

FIGS. 13 and 14, for example, show an interface or panel 1300 for conducting a deposit transaction. As shown, a user may designate any of the accounts 1305, 1310, or 1315 into which a check deposit will be made. In some embodiments, the user may designate the particular checking by taking a picture or scanning the deposited check, or otherwise importing check and deposit data needed for the deposit transaction. As shown in the right hand side of 1300, there is a designated area or box 1320 for the user to fill-in with the desired account 1105, 1110 or 1115. As described herein, the user may designate the desired account by dragging and dropping the account into 1320, double-tapping the desired account, or otherwise designating the desired account to be associated with 1320 and the deposit transaction. FIG. 14 shows the user having selected account 1305, the Smith Family Checking Account, as the account to which the $350 deposit will be made. As shown, the user also has the ability to designate a different payment amount and the date upon which payment will be made.

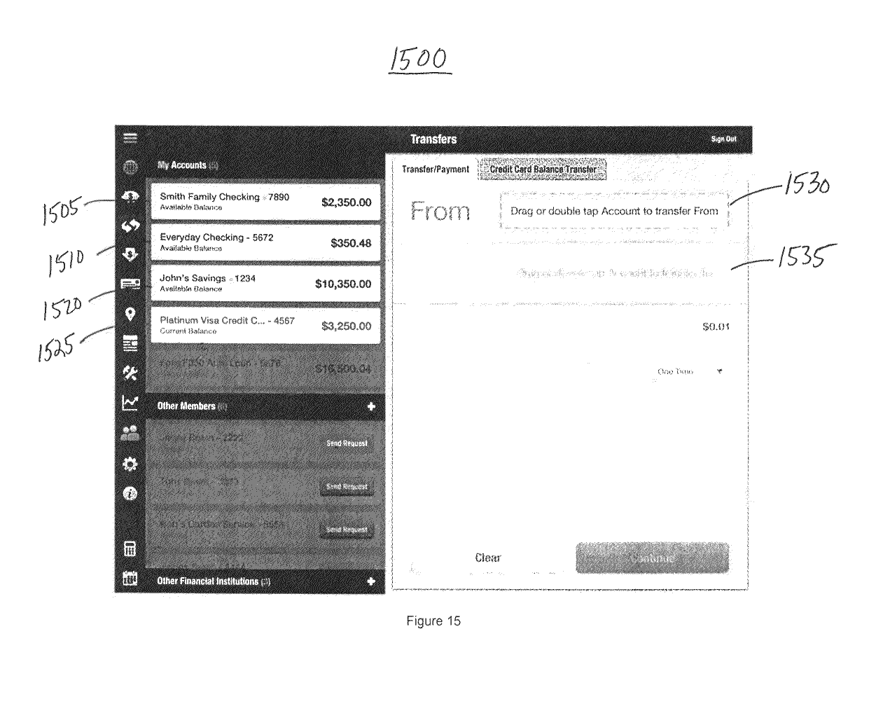

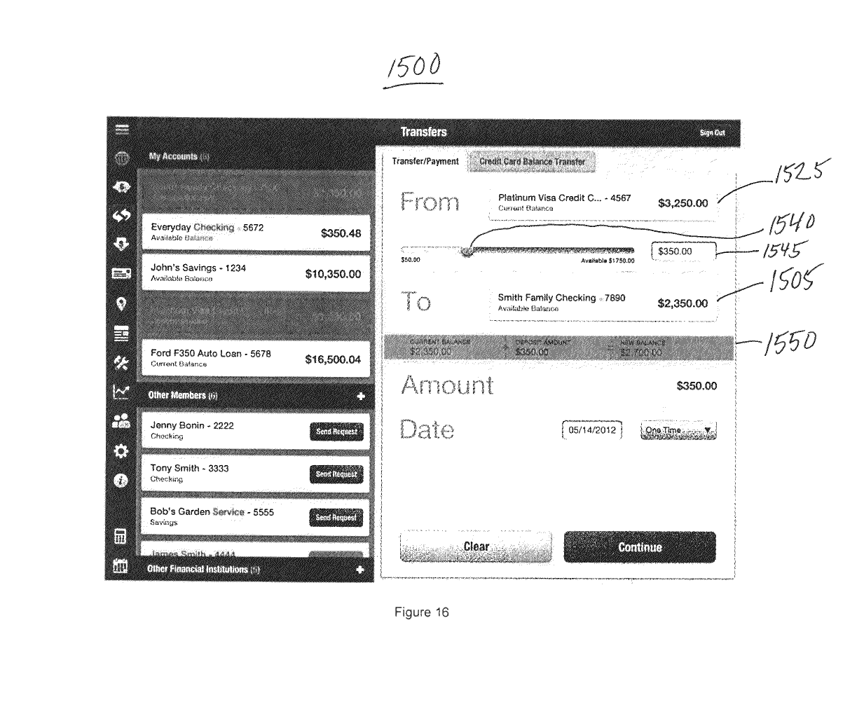

FIGS. 15 and 16, for example, show an interface or panel 1500 for conducting a transfer transaction. As shown, a user may designate any of the accounts 1505, 1510, 1520 or 1525 to make a funds transfer. The gray shaded accounts on the left hand side of 1500 may correspond to accounts from which funds cannot be transferred, such as, for example, loans or other such accounts. In some embodiments, accounts module 144, for example, may determine the eligible accounts. As shown in the right hand side of 1500, there is a designated “From” area or box 1530 for the user to fill-in with the desired account 1505, 1510, 1520 or 1525 from which the funds will be transferred. As described herein, the user may designate the desired account by dragging and dropping the account into 1530, double-tapping the desired account, or otherwise designating the desired account to be associated with 1530 and the transfer transaction. The right hand side of 1500 also shows a “To” area or box 1535 for designating an account to which the funds will be transferred.

FIG. 16 shows the user having selected account 1525, the Platinum Visa Credit Card, as the “From” account, and 1505, the Smith Family Checking Account, as the “To” account. As shown, interface 1500 may now present a slideable element 1540 for specifying the precise amount to be transferred. As described above, the user may selectively position element 1540 to correspond to the desired transfer amount. Alternatively, the user may designate the amount manually by entering an amount in box 1545. As shown, the user is able to transfer anywhere from a minimum of $50 to a maximum of $1750, as may be determined, for example, by accounts module 144 based on the account identity or any other information. Box 1550 may present the account balance of account 1505 after the transfer. As shown the user has the ability to select the date of the transfer and designate the transfer as a one-time or recurring transaction.

While the embodiments have been particularly shown and described within the framework of financial services and transactions, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, combinations of the present embodiments, and uses and advantages of the present invention will be apparent to those skilled in the art from consideration of the specification and practice of the invention disclosed herein. The specification and examples should be considered exemplary.

What is claimed is:

1. A method for executing a financial transaction via an electronic device, comprising the steps of:
receiving, electronically, a request to designate a first account for use in a financial transaction, wherein the first account is associated with a first account icon located in a first location of an interface;
receiving, electronically, a request to move the first account icon to a second location on the interface, wherein the second location is associated with the financial transaction; and
initiating, electronically, the financial transaction.

2. The method of claim 1 wherein the first account icon comprises a first account identifier or account number.

3. The method of claim 1 wherein the financial transaction comprises a deposit into the first account.

4. The method of claim 3 wherein the deposit is from another account.

5. The method of claim 3 wherein the deposit is from a deposited check.

5. The method of claim 1 wherein the request is received upon a user touching an icon displayed on a screen or display associated with the electronic device.

6. The method of claim 1 wherein the request to move the first account icon comprises a user dragging and dropping the movable funds container by touching a screen or display associated with the electronic device.

7. The method of claim 1 wherein the request to move the first account icon comprises a user double tapping the movable funds container by touching a screen or display associated with the electronic device.

8. The method of claim 1 wherein the electronic device is portable.

9. The method of claim 1 wherein the electronic device comprises a tablet, a smartphone, or personal assistant device.

10. A system, comprising:
a processor; and
a memory comprising computer-readable instructions which when executed by the processor cause the processor to perform the steps comprising:
receiving, electronically, a request to designate a first account for use in a financial transaction, wherein the first account is associated with a first account icon located in a first location of an interface;
receiving, electronically, a request to move the first account icon to a second location on the interface, wherein the second location is associated with the financial transaction; and
initiating, electronically, the financial transaction.

11. The method of claim 10 wherein the first account icon comprises a first account identifier or account number.

12. The method of claim 10 wherein the financial transaction comprises a deposit into the first account.

13. The method of claim 12 wherein the deposit is from another account.

14. The method of claim 12 wherein the deposit is from a deposited check.

15. The method of claim 10 wherein the request is received upon a user touching an icon displayed on a screen or display associated with the electronic device.

16. The method of claim 10 wherein the request to move the first account icon comprises a user dragging and dropping the movable funds container by touching a screen or display associated with the electronic device.

17. The method of claim 10 wherein the request to move the first account icon comprises a user double tapping the movable funds container by touching a screen or display associated with the electronic device.

18. The method of claim 10 wherein the electronic device is portable.

19. A system for conducting a financial transaction, comprising:
a user I/O module receiving instructions from a user regarding a financial transaction using a first account, wherein the instructions are provided by the user by touching a screen associated with a device;
an accounts module for processing data related to the first account and the financial transaction; and
a back-end systems communication module for transmitting data relating to the financial transaction.

20. The system of claim 19 wherein the instructions comprise the user dragging and dropping a movable funds container by touching a screen or display associated with the electronic device.
